(19) United States
(12) Patent Application Publication
(10) Pub. No.: US 2004/0005811 A1
(43) Pub. Date: Jan. 8, 2004

(54) Adjustable electrical tell tale modular unit and external monitor

(76) Inventor: Dennis Ronald Gravolin, Maclean (AU)

Correspondence Address: SHLESINGER, ARKWRIGHT & GARVEY LLP, 3000 South Eads Street, Arlington, VA, 22202, US

(21) Appl. No.: 10/607,482

(22) Filed: Jun. 27, 2003

Related U.S. Application Data
(63) Continuation-in-part of application No. 10/428,157, filed on May 2, 2003.

(30) Foreign Application Priority Data
May 13, 2002 (AU) 40593/02

(51) Int. Cl. H01R 11/00

(52) U.S. Cl. 439/503

(57) ABSTRACT

An electrical tell tale system comprises a main control unit forming part of a trailer connector. The main control unit is a moulded module or cut printed circuit board, which fits into the connector. The main control unit has aligned pin connections to connect to and monitor all of the existing connections in the connector. The main control unit module includes screw type connections for the wiring from the vehicle harness and a tell tale monitor. The main control unit module is housed in the connector and by its connections changes the normal operation of the trailer connector to monitor all of its housed circuit connection in one complete unit.

### INTRODUCTION TO THE PARENT INVENTION AND THE ADDITION

The Electrical Tell Tale System for Trailers, U.S. Pat. No. 833,898 is a device which monitors the electrical systems of trailers and communicates to the driver of a hauling vehicle if those trailer circuits are operating correctly or are malfunctioning. The Electrical Tell Tale System for trailers consists of a main control unit which is mounted at the rear of the vehicle and wired in series with each trailer circuit. From the main control unit is a modular cable which runs to the instrument panel of the vehicle and at this end of the cable is the tell tale monitor which houses a number of light emitting diodes. The light emitting diodes indicate to the driver whether the trailer circuits are functioning correctly.

The addition of the original invention is based on the main control unit and its casing, connections, electronics, and tell tale monitor. The electronics of the original invention are now formed in specific molded and designed “modules” or printed circuit boards (PCBs) which are able to be housed and fitted in any type of common trailer connector, including male, female connectors and adapters. This design forms a new generation trailer connector with an Electrical Tell Tale Safety System combined. Furthermore there has been additions to the electronics of the main control unit in order for the original current sensing switch to become adjustable to differing current loads making it adaptable to light emitting diode (LED) automotive lamps. Finally, an external monitor has been developed in order to be mounted on a caravan or trailer in order for the driver to see it and any people outside the vehicle, indicating the electrical safety state of the caravan or trailer.

### SUMMARY OF THE ADDITION

With reference to the original invention, the main control unit was housed in an epoxy filled plastic housing which has two leads coming out either side, and these leads where distributed into connectors to connect the main control unit to the trailer wiring loom of the vehicle. With the addition, the main control unit is now placed at the end of the vehicles trailer wiring harness, actually inside the trailer connector, it can be adjusted to suit different trailer lamp combinations, such as LED lights and an external tell tale monitor has been developed to be used with the new concepts, however, the internal tell tale monitor as in the original patent is fully adaptable and vice versa.

The main control unit's electronic component's, and its main connections are epoxy molded in modules or printed circuit boards which can be a number of differing cut or molded shapes, specific to common trailer connector types. The main connections of the main control unit protrude from the module and are aligned for exact and accurate fit with any trailer connectors. All connections including the tell tale monitor connections are now screw type connections. This design eliminates the need for the vehicles wiring to be modified as the system is now housed in the actual trailer connector and acts as an addition to the vehicle instead of a modification. The module is designed to monitor all trailer connections within the plug or a specified number of connections. The main control unit, and tell tale monitor operate the same sequence as the original invention, however it can now be adjusted using a variable or fixed resistor incorporated after the current sensing coil to monitor any required number of trailer lights instead of the unit being set at a fixed current loading. The tell tale monitor, now external can be mounted on the caravan or trailer and its indicating LED lights, have the same circuit for color combination as in the original invention. The new monitor can bee seen in the drivers rear side view mirror and by any passing person to indicate the electrical safety condition to not only the driver themselves but to any external persons outside the motor vehicle. The addition is a convenient new step in the housing, connections fitment adaptability and visibility of the invented system. A Tell Tale System being part of a trailer connector that is adjustable to any type of trailer lighting combinations that can be used with an external tell tale monitor forms a new age in trailer connections.

### DESCRIPTION OF THE DRAWINGS

FIG. 1 Shows the main circuitry of the main invention showing the main addition of the trailer connector housing and how the connections of the main control unit are now enclosed in the trailer connector housing. The additions to the inventions circuitry are also shown, mainly resistor for the adjustable loading capabilities and resistors for LED protection. This figure also shows the capability of the module monitoring all trailer connections within the plug.

FIG. 2 Shows the main control unit module for the common type seven pin flat trailer plug and its main connections.

FIG. 3 Shows the main control unit module for the common type large seven pin round trailer connector and its connections.

FIG. 4 Shows the main control unit module for the common type seven pin round trailer connector and its connections.

FIG. 5 Shows the Standard pin out of the seven pin flat trailer connector

FIG. 6 Shows the outline of a standard seven pin flat trailer connector

FIG. 7 Shows the connection side of the standard seven pin flat trailer connector.

FIG. 8 Show the Main Control Unit Module for the Seven pin flat trailer connector in relation to all other drawings on the page.

FIG. 9 Shows the Main Control Unit Module for the seven pin flat trailer housed in the seven pin flat trailer connector and all of its connections.

FIG. 10 Show the pin out for the large seven pin round trailer connector

FIG. 11 Shows the outline of the large seven pin trailer connector

FIG. 12 shows the connection side of the large seven pin trailer connector

FIG. 13 Shows the Main Control unit module for the large seven pin trailer connector in relation to all other drawings on the page.

FIG. 14 Shows The main control unit for the large seven pin trailer connector housed in the large seven pin trailer connector and all of its connections.

FIG. 15 shows the pin out of the seven pin trailer connector

FIG. 16 Shows the outline of the seven pin trailer connector.

FIG. 17 Shows the connection side of the seven pin trailer connector.

FIG. 18 Shows the main control unit module for the seven pin trailer connector with reference to all other drawings on the page.

FIG. 19 shows the main control unit for the seven pin trailer connector in the seven pin trailer connector and all of its connections.

FIG. 20 Shows an example of a standard seven pin flat male plug

FIG. 21 Shows an example of a standard Large Seven Pin round male plug

FIG. 22 Shows an example of a standard seven pin plug.

FIG. 23 Shows an Example of a Seven pin flat plug to seven pin round plug trailer adapter

FIG. 24 Shows an example of Seven flat trailer connector to a large seven pin plug trailer adapter.

FIG. 25 Shows an example of Seven pin plug to large seven pin plug trailer adapter

FIG. 26 Shows the printed circuit board of the external tell tale monitor

FIG. 27 Shows a side view of the new tell tale monitor

FIG. 28 Shows the front view of the tell tale monitor and led lights

FIG. 29 Shows the complete system and connections

FIG. 30 Show the complete system installed on a vehicle and operating.

### DETAILED DESCRIPTION OF THE ADDITION

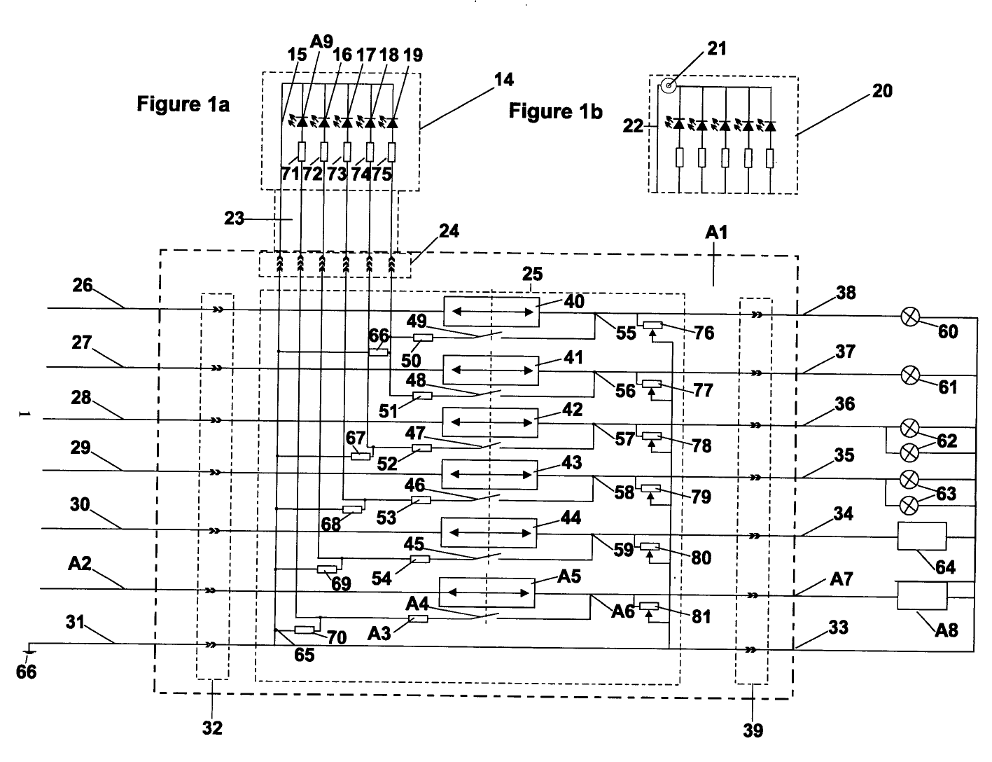

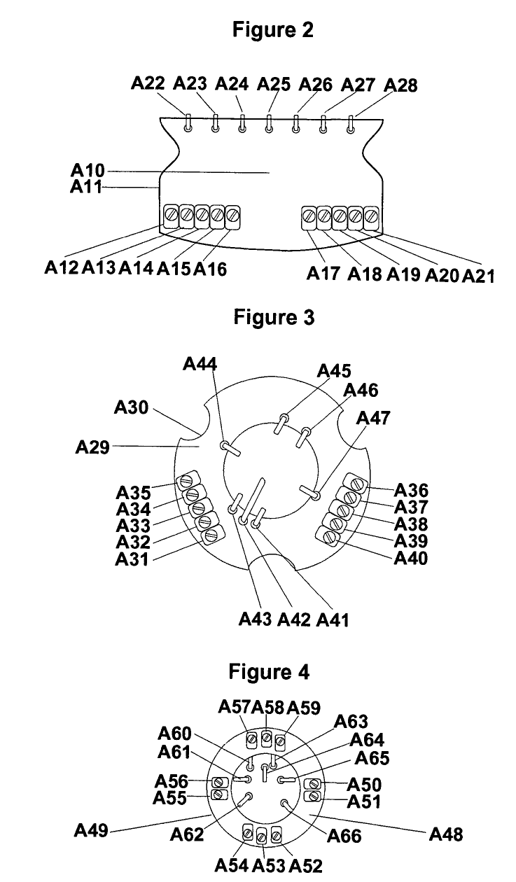

With reference to FIG. 1a the original inventions circuitry can be seen and its operation is identical to the patented design together with the following additions. 25 shows the original epoxy casing which is now in the form of a accurate molded module or printed circuit board as can be seen in FIGS. 2 to 4. A1 represents the trailer connector that forms the complete housing of the main control unit which encases all connections combining the trailer connector itself and main control unit as one unique device.

A2 to A8 show the capability of the main control unit module to monitor all connections with in the trailer connector. A2 to A8 shows an auxiliary circuit and A3 to A6 shows the current sensing switch for the circuit. A9 in the tell tale monitor is the light emitting diode for the auxiliary circuit. Again the additions of A2 to A9 and FIG. 1b showing the additional light emitting diode for the additional circuit demonstrate the capability of the module to monitor all circuits within the trailer connector. 66 to 70 are also additional to the original invention. 66 to 70 are pull down resistors to earth 66. 66 to 70 protect the light emitting diodes, A9, and 16 to 19 in the tell tale monitor 14, from illuminating by any interference from external sources such as moisture or feedback. 71 to 75 are resistor housed in the tell tale monitor 14 to protect the LEDs, A9, 16 to 19 from high current in the case of circuit malfunction or tampering. 76 to 80 are either variable or fixed resistors that are placed anywhere in each circuit after the current sensing switches 40 to 44 and A5. 76 to 80 are connected to earth 66 and allow the current sensing switches 40 to 44 and A5 to be adjusted to suit varying trailer load currents of 60 to 64 and A8. Resistors 76 to 81 can be fitted inside the main control unit A1 or after 38 to 34 and A5 and before 60 to 64 and A8 providing resistors still are grounded to earth 66.

FIGS. 2 to 4 show in detail the modules A10, A29, A48, their distinctive outlines A11, A30, A48 and their connections A12 to 28, A31 to A47 and A50 to A65 for the three common connector types, however the modules can be adapted to suit any trailer connector available.

A12 to A21, A31 to 40 and A50 to 59, are the connections from the vehicles trailer wiring harness into the main control unit, these connections also incorporate the connections for the tell tale monitor. They are of a screw type connector. All connections A12 to A21 incorporate connections all connections 26 to 31 in FIG. 1 and all tell tale monitor connections in 2, FIG. 1a.

Connections A22 to A28, A41 to A47 and A60 to A66 are the main control units connection to the trailer connector itself. These connections are the same as 33 to 38 and A7 of FIG. 1a. However the locations of these connections are not relevant to 33 to 38 and A7 of FIG. 1a. These connections of A22 to A28, A41 to A47 and A60 to A66 are connector pins with ferules that can be placed into the connections of the trailer connector and then tightened.

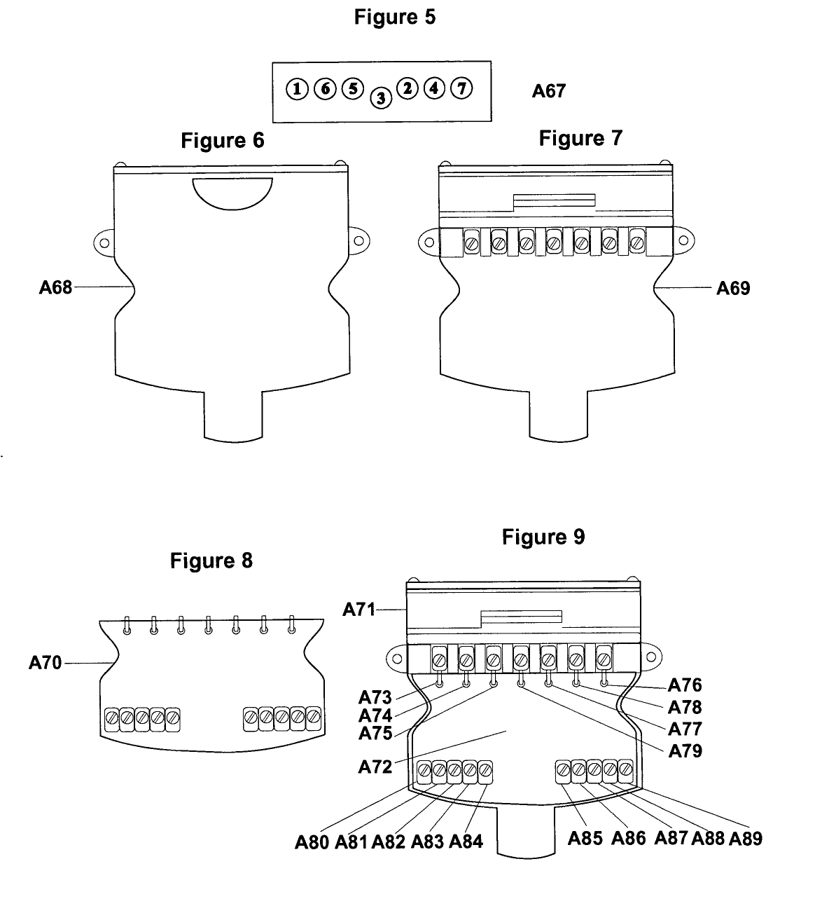

FIGS. 5, 6, 7, 8 and 9 describe how the main control unit A70 is mounted into the standard seven pin flat trailer connector, A67, 68 and 69. A71 in FIG. 9 shows the new generation trailer connector with the main control unit A72 of the Electrical Tell Tale Safety System installed. A75 to A79 are the main connections of where the main control unit modular A72 is connected to the main connections of the trailer connector. These connections are the output for the trailer circuits as in 33 to 38 and A7 of FIG. 1a. A80 to A89 are the connections which now take the place of the connection now used by A75 to A79. A80 to A89 are for all connections from the vehicle to the trailer connector, and also all tell tale monitor connections. It can be seen that the main control unit module A70 fits neatly into the connector A67 to A69 and forms one complete unit A71.

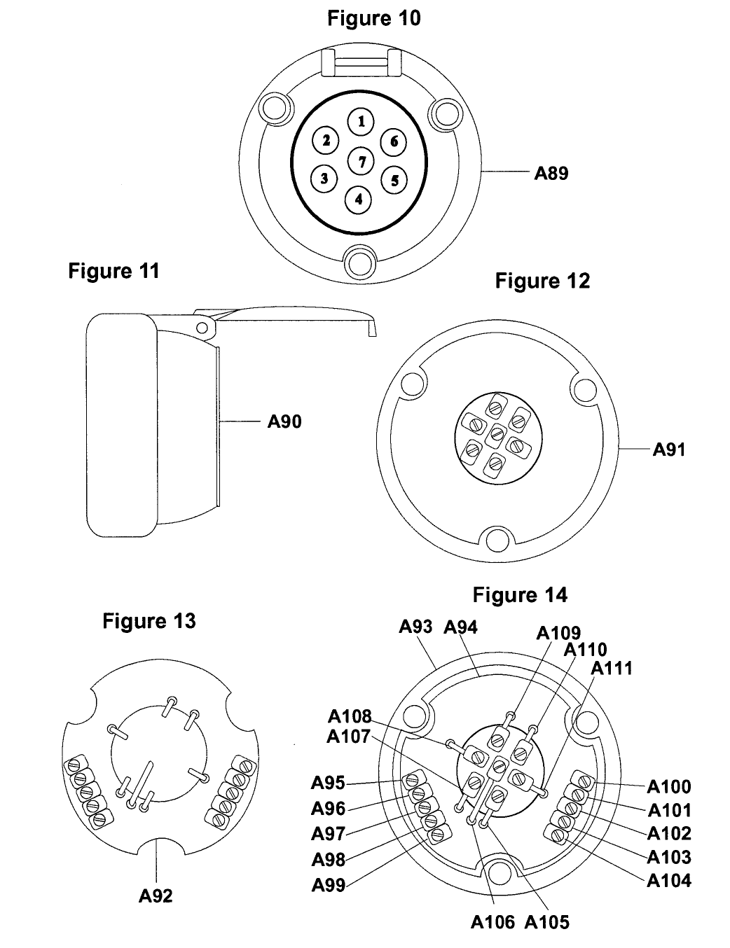

FIGS. 10 to 14 demonstrate how the main control unit module for the large seven pin round trailer connector A92 is fitted into the connector. A89 shows the pin out of the common pin out for the large seven pin connecter, A90 is the outline, and 91 shows the connections side of where A92 the main control unit is mounted. FIG. 14 shows the complete new generation connector A93 with the main control unit module connected A94. Connections 95 to 104 being from the vehicles trailer wiring harness and the tell tale Monitor, and take the place of connections A105 to A111 which are the main connection from the main control unit module A94 to the connector itself A91 these are the output for the trailer circuits when connected. It is again seen the main control unit module A92 is aligned and fits neatly into the connector housing A91 and the connections A105 to A111 are accurately positioned.

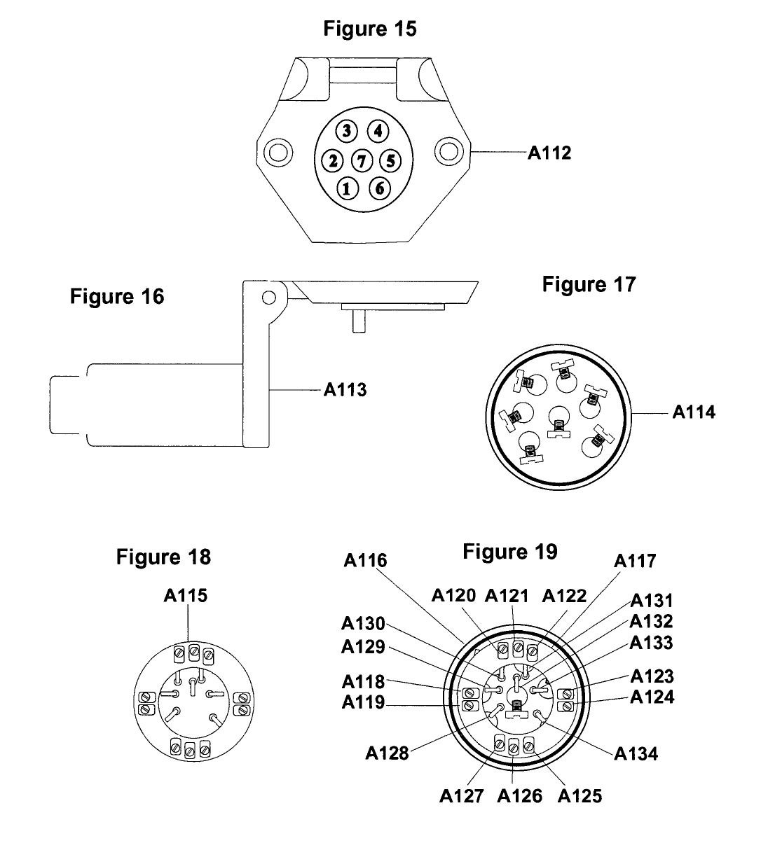

FIGS. 15, 16, 17, 18 and 19, is a description similar to the two previous, however this time the main control unit module A115 is housed in a seven pin round trailer connector, of which the pin outs A112, outline A113 and connection side of the connector A114 is shown. A116 shows the complete unit with the main control unit module A117 connected and forming part of the connector. A118 to A127 are the connections from the vehicles wiring harness and tell tale monitor and are of screw type. A128 to 134 are the connections form the main control unit a117 to the trailer connector A114 and go to the relatively trailer circuits.

A115 is aligned neatly to form A116 and all connection are positioned accurately.

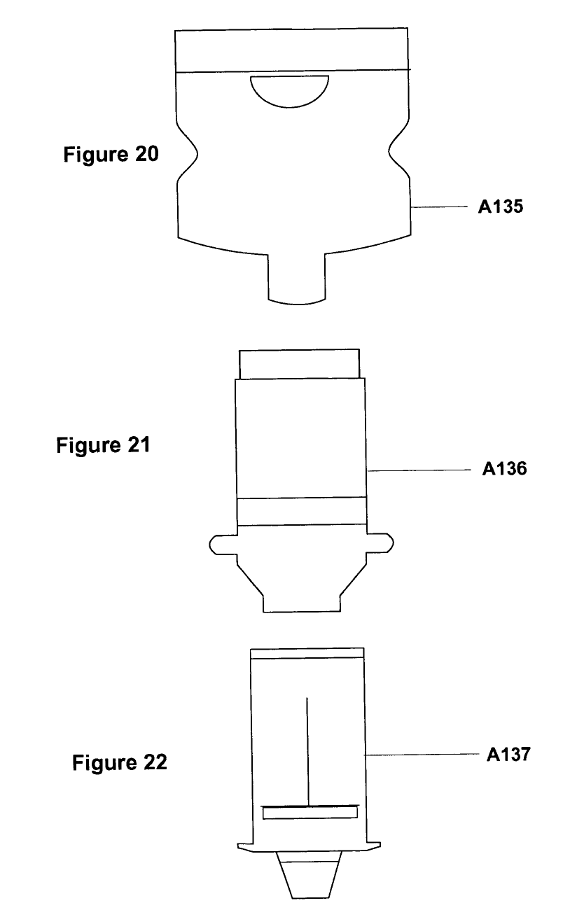

The main control units modules in FIGS. 2, 3, and 4 have the ability to be mounted into any designed trailer connector and form part of it. FIG. 20, 31 and 22, consisting of trailer connector plugs a135, A136 and A137 respectively show examples of connectors in which the main control unit be mounted in.

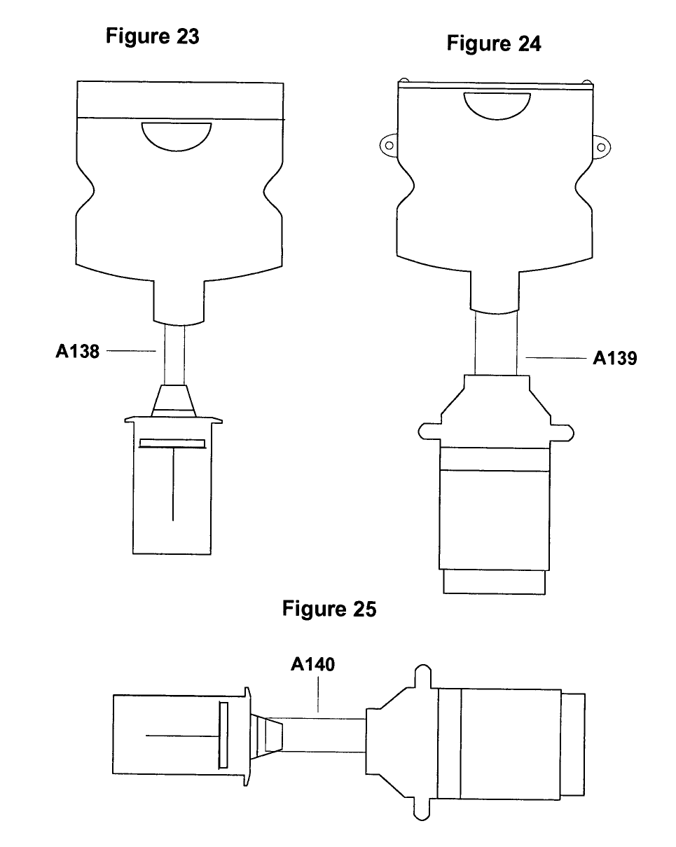

FIGS. 23, 23 and 25 show adapters A138, A139 and A140, also the main control unit is able to be monitored in these types of trailer connections.

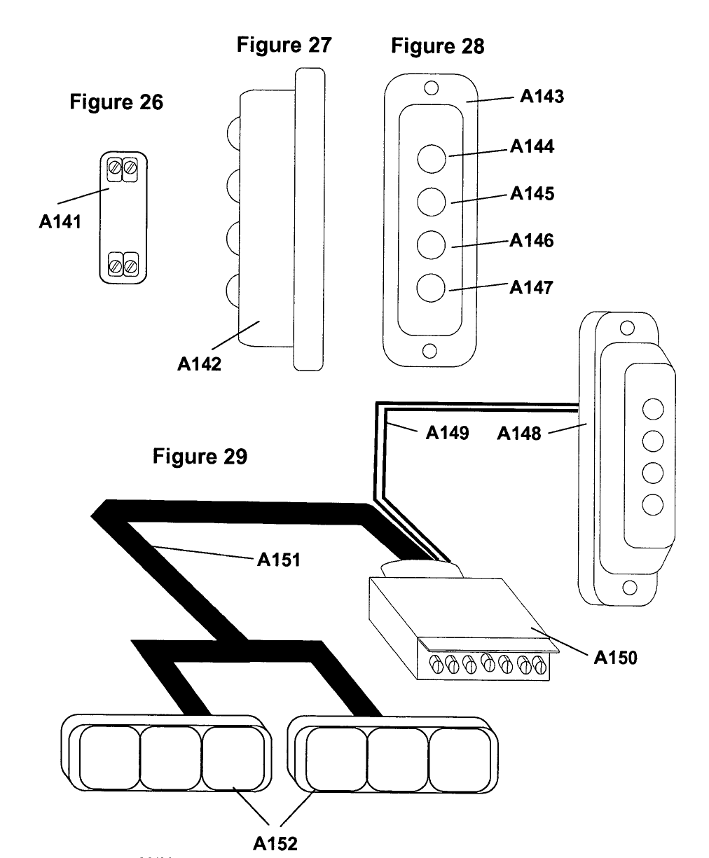

FIG. 26 shows the printed circuit board A141 of the external tell tale monitor shown in FIGS. 27 and 28, A142 and A143. This is respective to 14 in FIG. 1a. A141 is inserted into A142. A143. A144 to A147 are the light emitting diodes respective to A9, 16 to 19 in FIG. 1a. In this case the monitor is only monitoring four circuits, but has the ability to monitor all circuits of FIG. 1a. A144 to 147 are different colored light emitting diodes respective of each circuit in the original invention. The order of the circuit/led combination 144 to 147 on the tell tale monitor 142 and 143 can be in any order, colors of 144 to 147 are red for brake light circuit, green for turn indicator circuit, amber for clearance light circuit and blue for electric brake circuit.

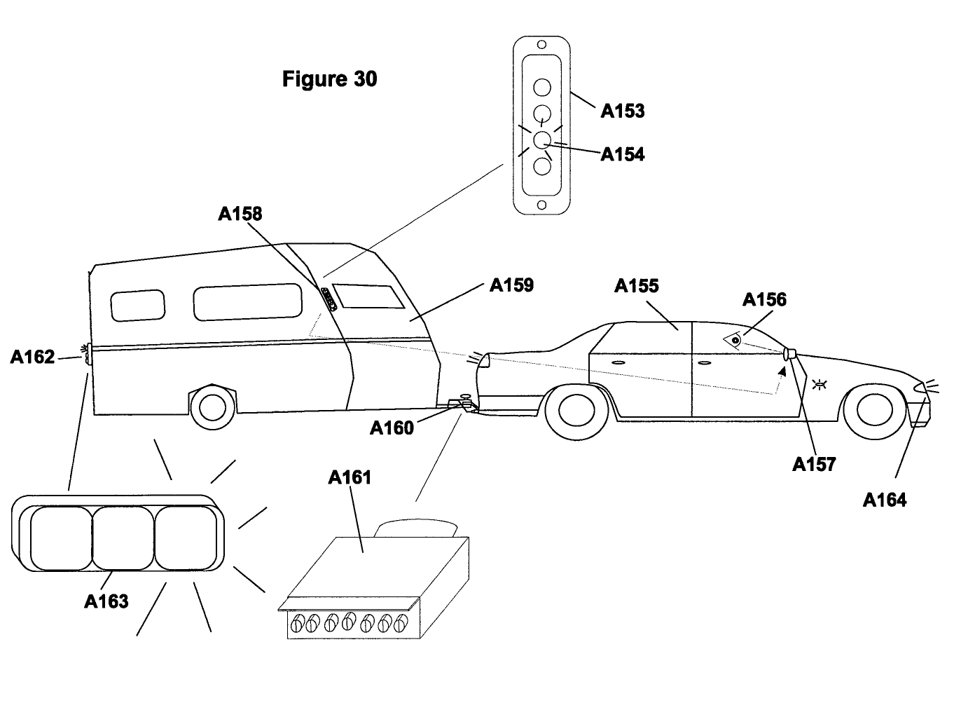

FIG. 29 shows the invention completely connected, the main control unit A150 housing the main electronics as in FIG. 1a, A1. This is connected to a modular cable A149 respective of 23 in FIG. 1a. The other end of A149 is connected to the PCB A141, FIG. 26 which is housed in the external tell tale monitor A148. From A150, the main control unit, A151, a seven core cable is connected. A151 carries all wires 33 to 38 and A7 in FIG. 1a. The opposite end of the cable A151 is connected to A152, which represents the trailer lights, which can be seen in 60 to 63 in FIG. 1a. All wire connections within A148 and A150 are screw type onto the PCB as shown in FIG. 2 to FIG. 4.

FIG. 30 shows the positioning of the main components and the operation on the vehicle. The vehicle, A155 has its right indicator on, A164, normally this causes 162, 163 the trailer lamps to flash providing they are working correctly. The external monitor A153 is fitted at point A158 on the caravan A159. The main control unit A161 is fitted at point A160 to replace a normal trailer connector. A161 can either be a male or female plug, A60, A90, A113 or A135 to A137. The driver A156 can see that the light is working on the caravan A159 by looking at the tell tale monitor A158 in their rear view mirror A157. A154 shows the tell tale monitor A153,A158 illuminating to indicated that circuit is functioning correctly. It achieves this by the circuitry of FIG. 1a, A1 which is housed inside A161 on PCBs as in FIG. 2 to FIG. 4, A10, A29, A49. A153,A158 is connected to A161 by modular cable as mentioned in FIG. 29 A149 and shown in FIG. 1a, 23. In the case of A162, A163 not operating A158, A153 would not work and the driver A156 would see no illumination of A158, A153 indicating that A162, A163 is malfunctioning. A161 achieves this by using the circuitry describes in FIG. 1a A1.

In all cases the main control unit module is able to be mounted into any existing and yet to be manufactured trailer connector by its specific molded designed and aligned connector pins, forming part of the connector/adapter itself . Together with the external tell tale monitor as described, this system changes the normal plugs operation to a complete unit that is able to monitor the condition of all of the connections and circuits of the trailer connector itself, this in turn forming a new generation trailer connector in the interests of road safety.

I claim:

1. An electrical tell tale system, comprising:
a main control unit forming part of a trailer connector;
said main control unit is a moulded module or cut printed circuit board, which fits into said connector;
said main control unit has aligned pin connections to connect to and monitor all of the existing connections in the connector;
said main control unit module including screw type connections for the wiring from the vehicle harness and a tell tale monitor;
said main control unit module being housed in the connector and by its connections changes the normal operation of said trailer connector to monitor all of its housed circuit connection in one complete unit.

2. An electrical tell tale system as in claim 1, wherein an external tell tale monitor connected to said main control unit and mounted on a caravan or trailer.

3. An electrical tell tale system as in claim 1, wherein said main control unit includes a variable or fixed resistors to accommodate for differing trailer circuit current loads.

4. An electrical tell tale system as in claim 2, wherein said main control unit and said tell tale monitor incorporate additional resistors for circuit protection.

5. An electrical tell tale system as in claim 1, wherein said trailer connector can be any existing trailer plug, socket or adapter.
